(19) United States
(12) Patent Application Publication
(10) Pub. No.: US 2013/0197953 A1
(43) Pub. Date: Aug. 1, 2013

(54) METHOD AND SYSTEM FOR IMPLEMENTING USER REPORTING

(71) Applicant: Oracle International Corporation, Redwood Shores, CA (US)

(72) Inventors: Keith SHOLES, Littleton, CO (US); Jeff ERICKSON, Denver, CO (US); Qiu ZHONG, Denver, CO (US); Na LI, Bellevue, WA (US)

(73) Assignee: ORACLE INTERNATIONAL CORPORATION, Redwood Shores, CA (US)

(21) Appl. No.: 13/754,871

(22) Filed: Jan. 30, 2013

Related U.S. Application Data
(60) Provisional application No. 61/593,098, filed on Jan. 31, 2012.

(51) Int. Cl. G06Q 10/06

(52) U.S. Cl. CPC G06Q 10/0631
USPC 705/7.12

(57) ABSTRACT

Disclosed are methods and apparatuses that efficiently provides for end user reporting from interactive applications. One embodiment provides an approach for implementing dynamic field selection for a user to select report parameters for an end user report using the user interface of an ERP application. User inputs are used to automatically generate queries to form a report data model usable by a reporting tool.

### CROSS-REFERENCE TO RELATED APPLICATIONS

The present application claims the benefit of priority to U.S. Provisional Application Ser. No. 61/593,098, filed on Jan. 31, 2012, which is hereby incorporated by reference in its entirety.

### BACKGROUND

Enterprise resource planning (ERP) systems integrate management information from the multiple different portions of an organization. A very common requirement for a user of an ERP system is the need to create reports over data from the ERP system. The ERP user is typically a functional expert who understands the data that he or she wants to report on. Reports are often highly personalized where the user needs to be able to choose the data fields and the selection criteria for the data to be included in the report, the types of calculation to be carried out by the report, as well as the content and layout (for example, charts, graphs or tables) of the report. Because they are so highly personalized, these types of specific reports are usually not included in the standard ERP product.

There are many challenges that make it difficult for end users to create reports in an ERP system. The ERP's interactive application provides the interface that users are most familiar with as they work within these applications as part of their day to day tasks. These applications allow users to easily query filtered data, but their reporting capabilities are very limited as compared to traditional reporting tools (and are normally limited to a data table).

In contrast, traditional reporting tools have sophisticated design features for layout and many choices for output format that users desire, but are outside of the interactive applications that the users normally work with. Because they typically do not interact with the ERP application and so must obtain data directly from the database or database middleware, these report creation tools require deep knowledge of the database schema and table relationships which make it very difficult for an end user to successfully use. In addition, the reporting tool often does not have access to any of the logic, transformations, and aggregations that may already have been performed on the data by the ERP application, and so it may be necessary to also duplicate the logic of the ERP application, creating unnecessary complexity when trying to generate end user reports for ERP systems.

Therefore, while the ERP user understands what it is they want to create in a report, they do not normally have the computer/application/software development skills necessary to create a report using traditional reporting solutions. The reports must normally be developed by specialized personal in an IT department or by external vendors. This means that it can become very costly to develop these types of reports with either internal IT departments or outside vendors.

As is evident, conventional systems do not offer effective and efficient solutions to enable end users to create these on-demand, highly personalized reports. ERP interactive applications are easy to use, but lack the reporting capabilities necessary. Traditional reporting tools offer sophisticated reporting capabilities but are too difficult for end users.

Therefore, there is a need for an improved approach for implementing reporting for interactive applications which addresses the problems of the prior approaches.

### SUMMARY

Some embodiments of the invention address the above problems using a method and apparatus that efficiently provides for end user reporting from interactive applications. One embodiment provides an approach of implementing dynamic field selection at an ERP application, where in user may make selections specifying a plurality of report parameters. Using an ERP query tool, queries are automatically generated based on the user's inputs to from a report data model. The report data model can then be loaded into a reporting tool and used to design a report definition. The report definition can then be used to render the end user reports.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

FIG. 1 illustrates an example system for implementing end user reports from an interactive tool according to embodiments of the invention.

FIG. 2A illustrates the components for implementing end user reports according to embodiments of the invention.

FIG. 2B illustrates a flowchart of an approach to implement end user reports according to embodiments of the invention.

FIG. 3 illustrates a flowchart of an approach for creating a report definition according to embodiments of the invention.

FIG. 4A illustrates a flowchart of actions taken by an ERP application to create a report data model according to embodiments of the invention.

FIGS. 4B-E illustrate example screen-shots of an ERP application where a user may enter inputs specifying data fields for a report.

FIG. 5A illustrates a flowchart of actions taken by the reporting tool for creating a report definition according to embodiments of the invention.

FIGS. 5B-C illustrate example screen-shots of a reporting tool where a user may specify a report layout using the report data model.

FIG. 6A illustrates a flowchart of actions taken by an ERP application to define a set of queries according to embodiments of the invention.

FIG. 6B illustrates an example screen-shot of an ERP application where a user may define a new query.

FIG. 7A illustrates a flowchart of an approach to execute a new report according to embodiments of the invention.

FIG. 7B illustrates an example screen-shot of an ERP application where a user may execute a report.

FIG. 7C illustrates an example screen-shot of an end-user report.

FIG. 7D illustrates another example screen-shot of an ERP application where a user may execute a report.

FIG. 7E illustrates another example screen-shot of an end-user report.

FIG. 8 illustrates a screenshot of an example interface for providing selection of data fields using this approach.

FIG. 9 illustrates the data fields displayed for selection within a reporting tool.

FIG. 10 illustrates that the report created in the reporting tool is made available within the ERP interactive application.

FIG. 11 illustrates a final end-user report.

FIG. 12 depicts a computerized system on which an embodiment of the invention can be implemented.

### DETAILED DESCRIPTION

Various embodiments are described hereinafter with reference to the figures. It should be noted that the figures are not drawn to scale and that the elements of similar structures or functions are represented by like reference numerals throughout the figures. It should be noted that the figures are only intended to facilitate the description of the embodiments. They are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments. In addition, for the purposes of illustration and explanation, the present disclosure is described in various embodiments in the context of ERP applications. It is noted, however, that the invention is not limited in its scope to ERP applications, and indeed, may be applied to other types of applications as well.

Some embodiments of the invention address the above problems by providing an approach for implementing end user reporting from interactive applications. One embodiment provides an approach for implementing dynamic field selection in the end user reports.

The present embodiment provides for an interactive application that allows users to query data with query capabilities. The users are able to select report parameters such as data fields to be included in the reports intuitively and directly from the interactive application screen. A metadata mechanism is employed to store the data fields (data model) of the reports. An interactive report design tool that allows user to design the report with a variety of charts, graphics and tables. An engine queries the data based on the user defined query criteria, packages the user selected fields within the data and generate the report output on the fly.

There are generally four steps that are needed to create any report. First is the definition of the data fields that will be included. It is critical that the correct data tables and fields are chosen to meet the desired report requirements. Next is the selection of the data to be included in the report. Data selection allows users to filter data so their report contains only those rows that are desired. Third is the definition of the report layout which defines visualization aspects of the report, e.g., selecting whether the data will be shown as a pie chart, vertical bar chart, pivot or data table, and whether there will be subtotaling, bold, italics, colors, titles, etc. The last step is to view the report output.

As noted above, the problem is that typical users of ERP systems (such as AR clerks) do not normally understand the intricacies of the ERP data model. This creates significant problems if the ERP user needs to create a new report.

The present embodiment provides an approach that allows the user to create a report by using an interface that he or she is most familiar with, that they work with as part of their day to day tasks. The present reporting solution merges the interactive applications that users are so familiar with along with a traditional reporting tool for robust report layout and output capabilities. The solution leverages the interactive ERP applications ease of use and familiarity for the selection of data fields to be included in the report and for the dynamic creation of queries to find the right data to report on. For a sophisticated report layout design and output tool where users can easily design the report with a variety of charts, tables and other graphics, one can utilize a reporting tool, such as the Oracle Business Intelligence (BI) Publisher tool. The interactive application and the reporting tool are tightly integrated for a seamless reporting solution that enables end users to easily create on-demand, highly personalized reports.

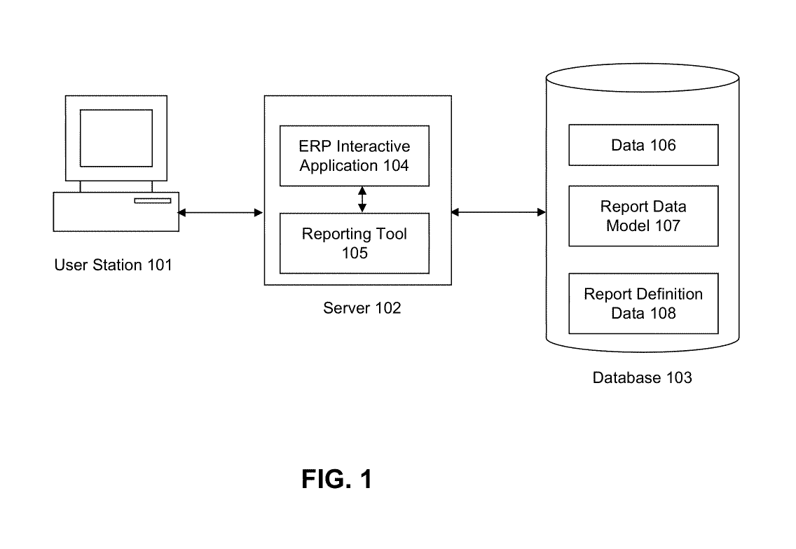

FIG. 1 shows an architecture of a system for implementing an end user reporting solution according to some embodiments of the invention. The users operate the system at user station 101 to access and utilize applications on an application server 102, such as an ERP interactive application 104 and a reporting tool application 105. The information needed by the user for creating and generating reports is stored in a database 103, including the report data model 107, report definition data 108, and the underlying data 106. As described in more detail below, the users will use the ERP interactive application 104 to generate a report data model 107 to hold metadata for the new report. The new report is designed and its definition is stored in the report definition data 108. The new report can then be executed by querying the data 106 to present the report output to the user.

The ERP user at the user station 101 operates the system to generate the new report. The user station 101 comprises any type of computing station that may be used to operate or interface with the application server. Examples of such user stations include for example, workstations, personal computers, laptop computers, or remote computing terminals. The user station 101 comprises a display device, such as a display monitor or screen, for displaying interface elements and report data to the user. The user station 101 may also comprise one or more input devices for the user to provide operational control over the activities of the system, such as a mouse, touch screen, keypad, or keyboard. The users of the user station 101 correspond to any individual, organization, or other entity that uses system to access applications on application server 102, such as the ERP interactive application 104 on the application server 105.

The database 103 corresponds to any type of computer readable mediums or storage devices. The computer readable storage devices comprise any combination of hardware and software that allows for ready access to the data within the database. For example, the computer readable storage device could be implemented as computer memory or disk drives operatively managed by an operating system.

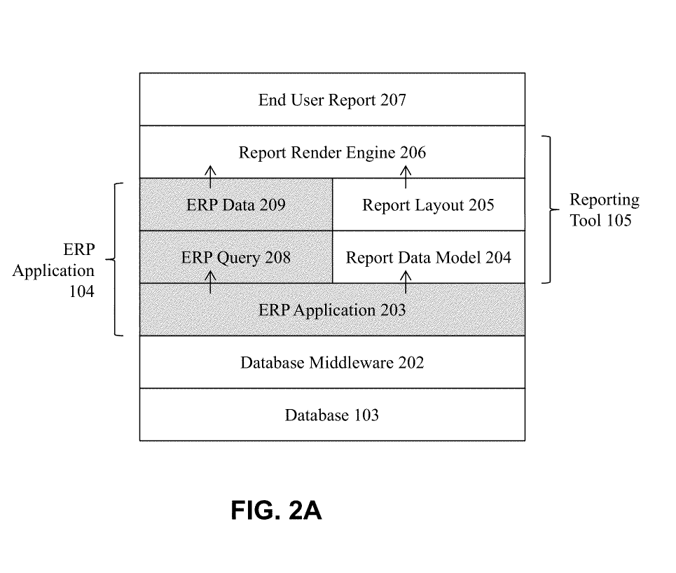

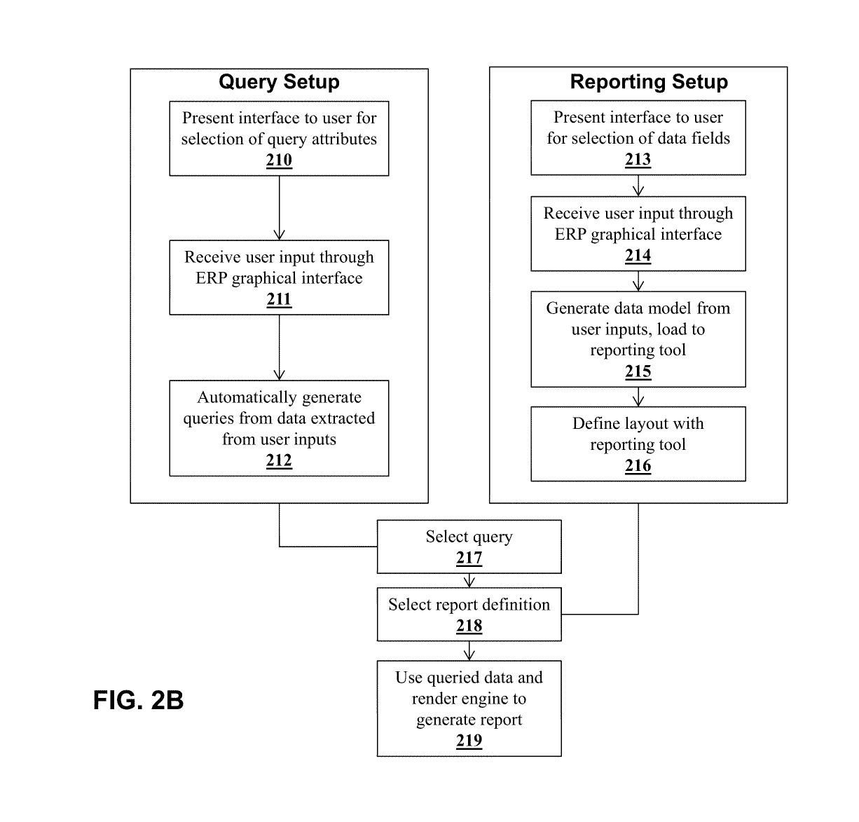

FIG. 2A identifies the components for an approach for generating end-user reports for an ERP system, according to some embodiments of the invention. Database 103 contains the data from which the end user desires to create an end user report. In some systems, applications must go through database middleware 202 in order to access the data on database 103. In other embodiments, database middleware 202 is not necessary and applications are able to access database 103 directly. The approach uses an ERP application 104 and a reporting tool application 105. In some embodiments, these applications may be independent, so that combinations of different ERP applications and different reporting tools may be used depending on how they are configured.

An ERP interactive application 203 retrieves data from database 103, and may process and performs conversions, aggregations, and other logic on the retrieved data. An example of a suitable ERP interactive application is the JD Edwards EnterpriseOne application, available from Oracle Corporation of Redwood Shores, Calif. Users of ERP systems will be familiar retrieving and processing data with the ERP interactive application, which will generally provide a user interface that does not require the user to have a deep understanding of the schema of the underlying database 103.

The ERP interactive application 203 in accordance with embodiments of the invention also allows the user to specify data fields for which to create a report. In some embodiments, the ERP interactive application 203 may display queried data to the user, allowing the user to select which data fields are to be included in the report. Methods for selecting data fields for the report may include clicking on a button next to the desired data fields, or dragging and dropping the displayed data fields. Once the user has finished selecting the desired data fields for a report, the selections may be saved as a report data model. In some embodiments, the report data model may be saved as an XML file capable of being loaded by reporting tool 105.

Generating a report requires both the actual raw data for the report, and instructions on how the data will be formatted and displayed. ERP query tool 208 and ERP data 209 are used to handle the actual data for the report, while reporting tool 105, comprising report data model 204 and report layout tool 205, is used to handle the instructions for formatting and displaying the data.

ERP query tool 208 is an interface where a user can define queries to retrieve the raw data that they wish to generate a report on. The ERP query tool 208 can automatically create queries in response to user selections without the user needing to have a deep understanding of the underlying database schema. In some embodiments, the ERP query tool may display data to the user, allowing the user to select one or more data fields and then define query criteria based on the selected data fields. Methods for defining query criteria may include clicking on a button next to a desired data field to select the data field, and then defining one or more query criteria by selecting the criteria at one or more menus, without the need for the user to write any database queries. Instead, the necessary queries are generated automatically by the ERP query tool based on the user's selections and inputs.

Once the ERP query tool 208 has automatically generated queries based on the user's selections and inputs, the generated queries may be run on the database 103 in order to produce the ERP data 209. The ERP data 209 comprises the actual raw data that will be used in the end user report.

While the ERP application 104 is responsible for the actual data to be used in the report, the reporting tool 105 is responsible for how the data is to be formatted and displayed in the report. The reporting tool 105 comprises the report data model 204 and report layout tool 205. Report data model 204 comprises the data fields that the user wishes to create a report on. This information is received from the ERP application by loading a saved report data model created by the user at the ERP interactive application 203. The received information may be converted to form a representation of the data fields that usable by the report layout tool 205 for defining a report layout. For example, data fields extracted from the loaded report data model may be displayed as a list to the user that can be used with report layout tool 205.

The report layout tool 205 is an interface in the reporting tool that allows the user to create a layout for the report using the data in the report data model 204. The layout of the report comprises instructions specifying how the data of the report is to be displayed, and may include instructions for creating a plurality of data visualization elements, including tables, charts, and graphs based upon the data fields in the report data model 204. For example, the user may specify instructions to create a bar graph with a horizontal axis corresponding to a particular data field from the report data model 204. Once the user is finished defining a layout, it may be saved as a report definition.

The report render engine 206 is a tool that generates the actual end user report that is displayed to the user, and is invoked when the user desires to run a report. In order to run a report, it necessary to have both the raw data that is the subject of the report, as well as the instructions for how that data is to be displayed in the report. The report render engine 206 takes both the ERP data 209, comprising the data to be used in the report, and the report definition generated by the user using the report layout tool 205, comprising the instructions on how the data is to be displayed, and uses them together to generate the end user report 207, which is the finished report that is displayed to the user.

FIG. 2B illustrates a flowchart of an approach for implementing end user reports using the system illustrated in FIG. 2A. As described above, generating a report requires both the actual raw data for the report, and instructions on how the data will be formatted and displayed. These may be obtained in two parallel processes: query setup to create the queries used to extract the raw data from the database, and reporting setup to create the report definition comprising instructions on report format and layout.

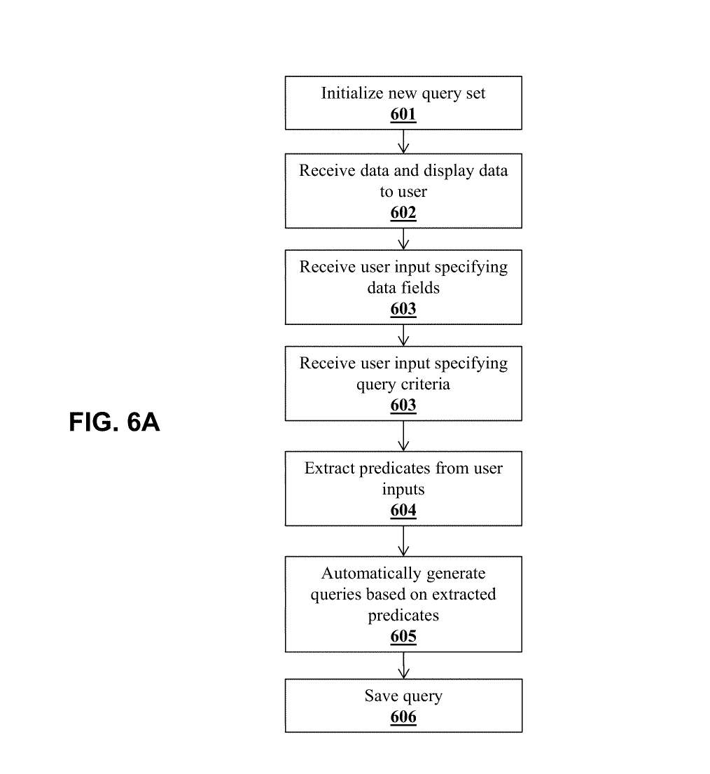

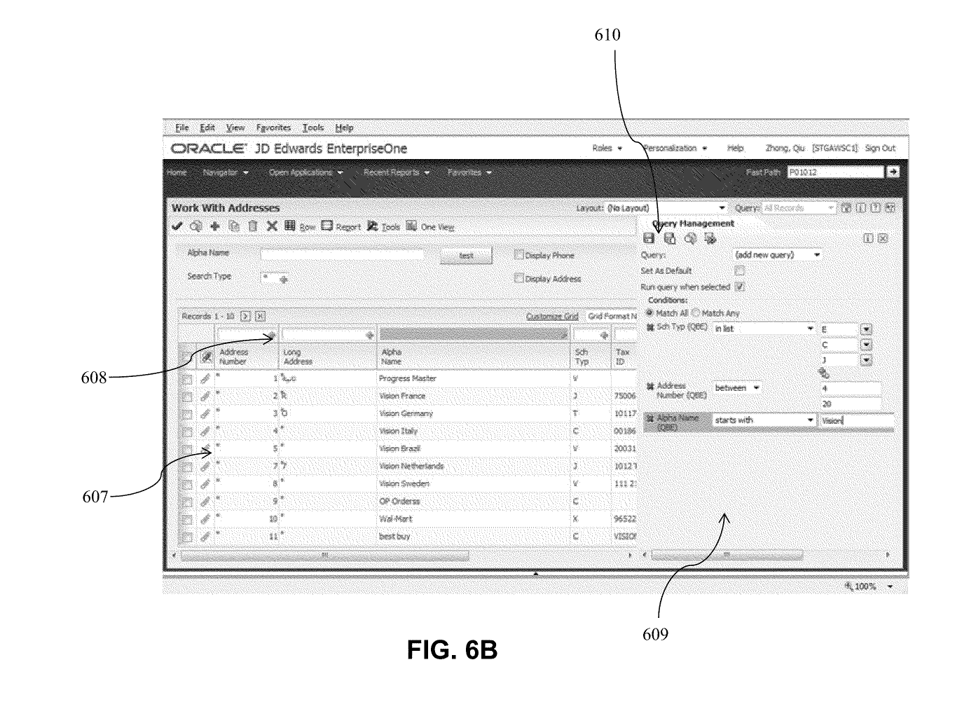

To perform query setup, ERP query tool 208 is used to present an interface to a user for selecting of query parameters at 210. This would allow users of the ERP application to define queries using the ERP graphical interface with which they are familiar with, without having to have detailed knowledge of the structure of the underlying database, or the technical knowledge of manually writing database queries. Next, at 211, the ERP query tool 208 receives the query parameters inputted by the user. For example, the ERP query tool 208 may display data fields to the user, wherein the user may select one or more data fields and define query criteria based on the selected data fields. The ERP query tool 208 then automatically generates database queries based upon the user inputs at 212. These generated queries may then be run on the database to return the raw data for the end user report. The query setup process is described in more detail below and in FIG. 6.

To perform reporting setup, the ERP interactive application 203 first presents an interface to the user for selection of data fields at 213. As with the query setup described above, the interface allows the user to specify data fields to be included in the report using the ERP graphical interface with which they are familiar with. At 214, the ERP interactive application receives user inputs through the ERP interface. Using the inputs received from the user, the ERP interactive application generates a data model specifying the data fields to be used in the report at 215. The data model generated by the ERP interactive application 203 is then loaded into the reporting tool 105 to form the report data model 204. By allowing reporting tool 105 to obtain the data fields for the report from the ERP application instead of directly from the database 102, a deep understanding of the underlying database structure and schema by the user is not required. Instead, only a familiarity with the graphical interface of the ERP application is needed.

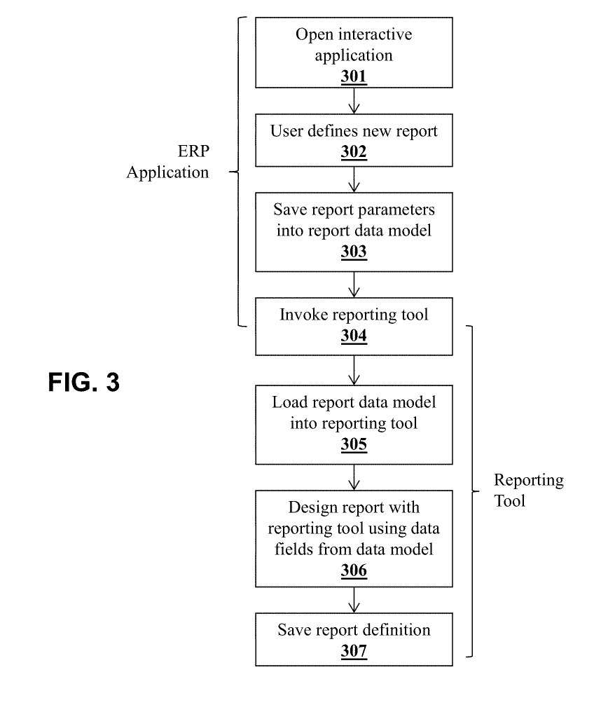

At the reporting tool 105, the data fields that comprise the report data model 204 may be displayed to the user. This allows the user to use the selected data fields with the report layout tool 205 to define a layout for the report at 216. The user may use report layout tool 205 to create various visual elements, such as charts, tables, and graphs, for which to represent the data fields contained in report data model 204. Once finished, the report layout is saved as a report definition. The reporting setup is described in greater detail below and in FIGS. 3-5.

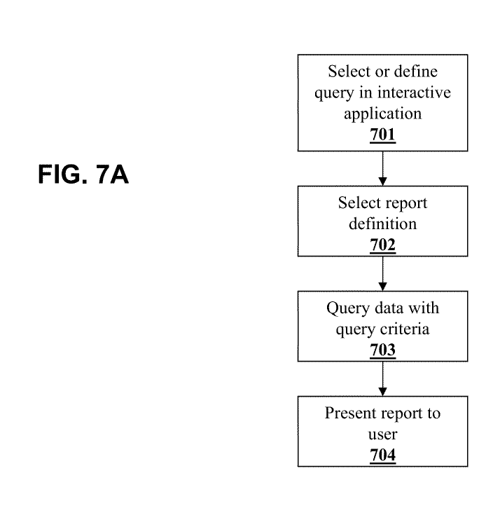

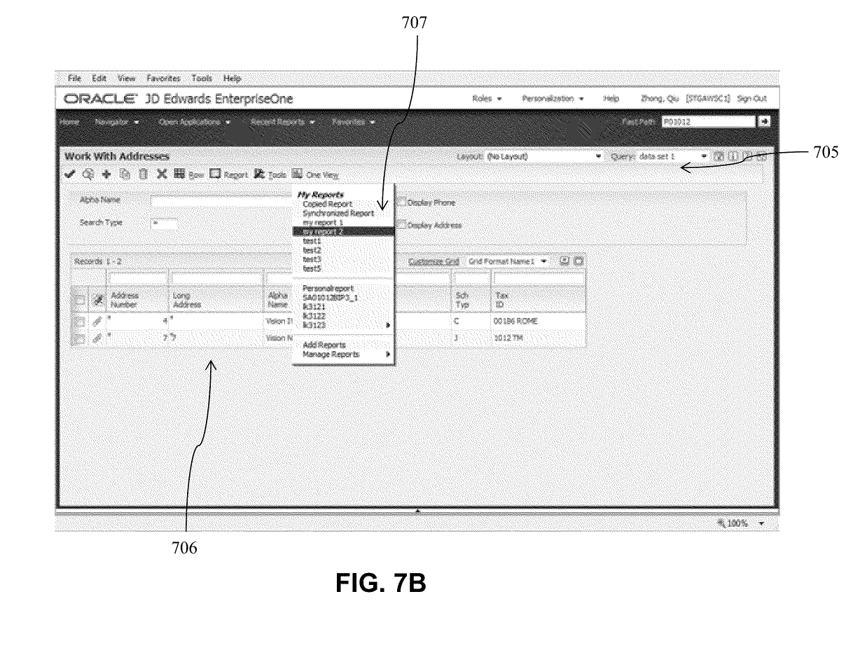

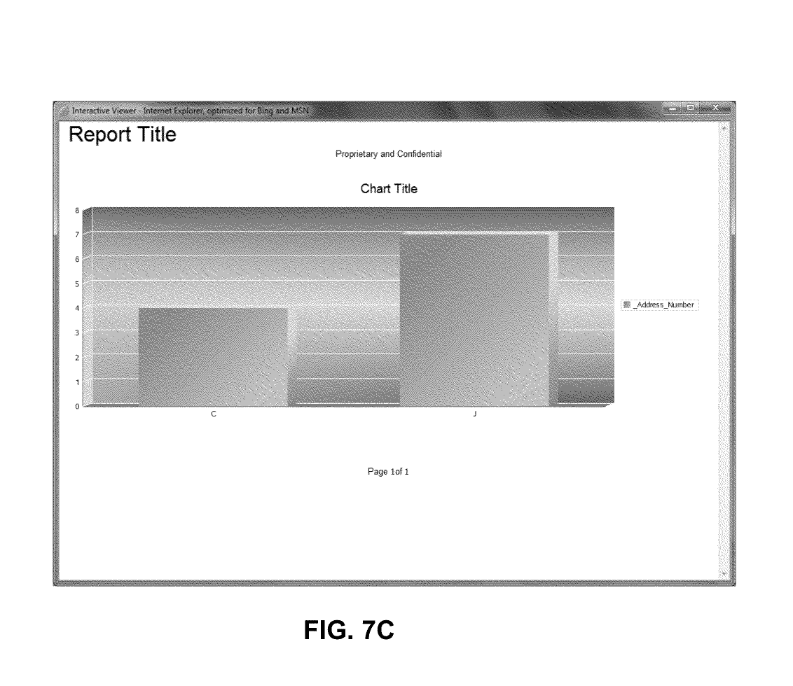

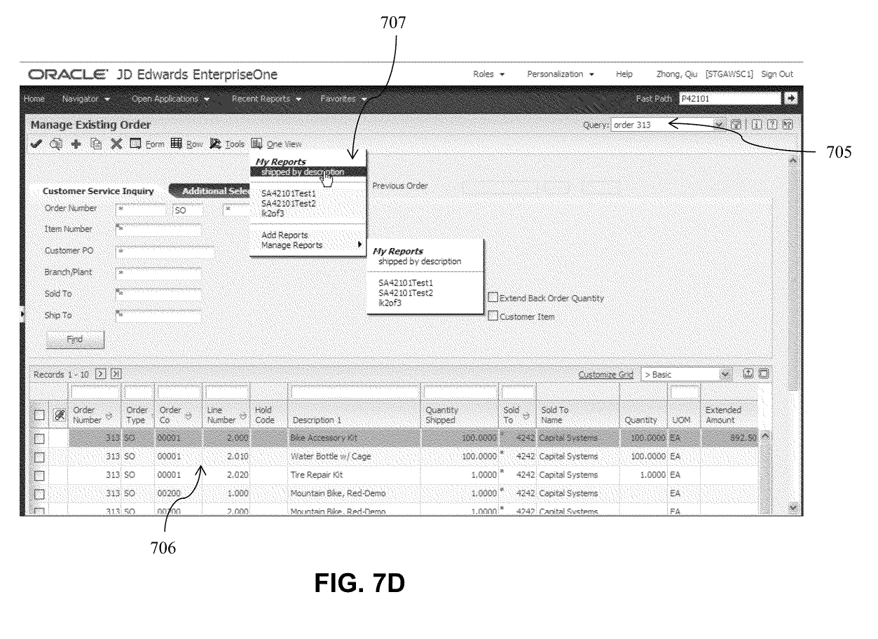

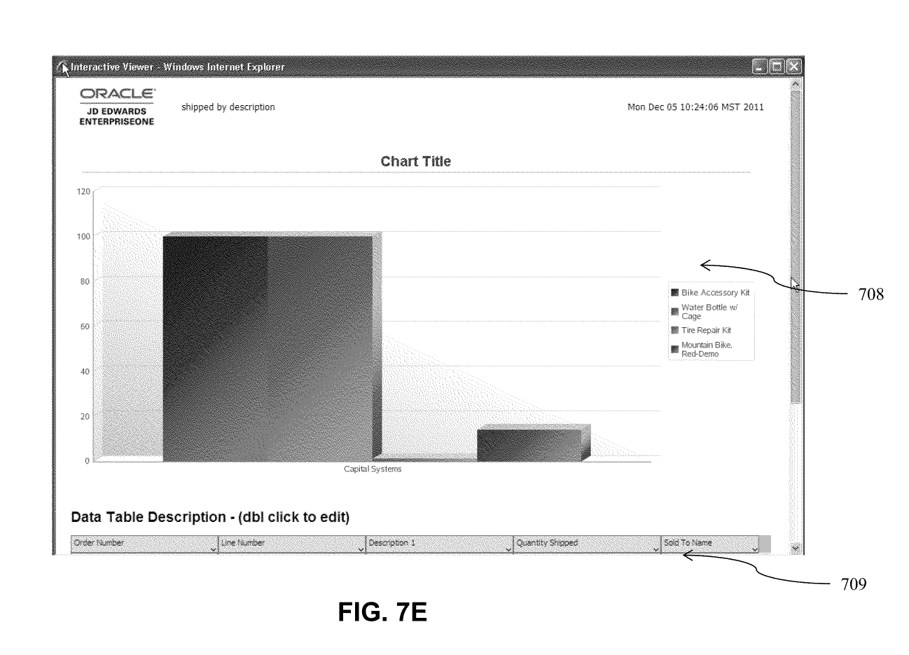

Once both the query setup and the reporting setup have been completed, an end user report can be generated. To do so, the user selects a query at 217, and then selects a report definition at 218. At 219, the user-selected query is used to query the database to produce ERP data 209. There may be multiple combinations of queries and report definitions available. This data comprises the raw data for the report, which is then used by the report render engine 206 with the user-selected report definition, comprising the instructions for the layout of the report, to generate the end user report 207. Executing a report is described in greater detail below and in FIG. 7.

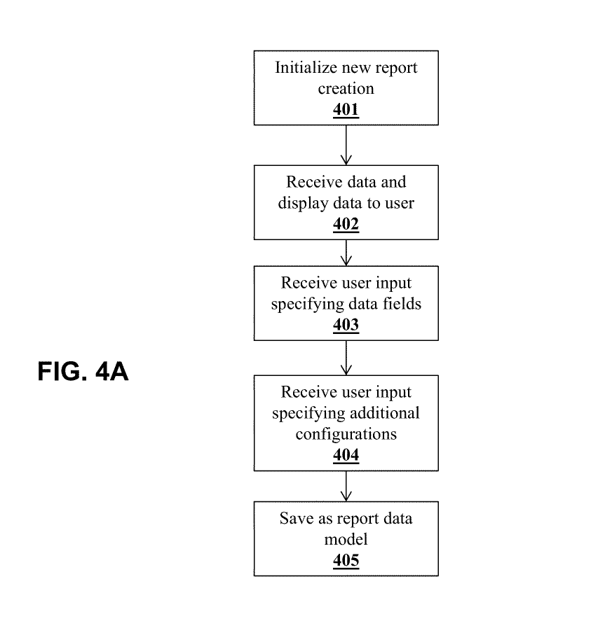

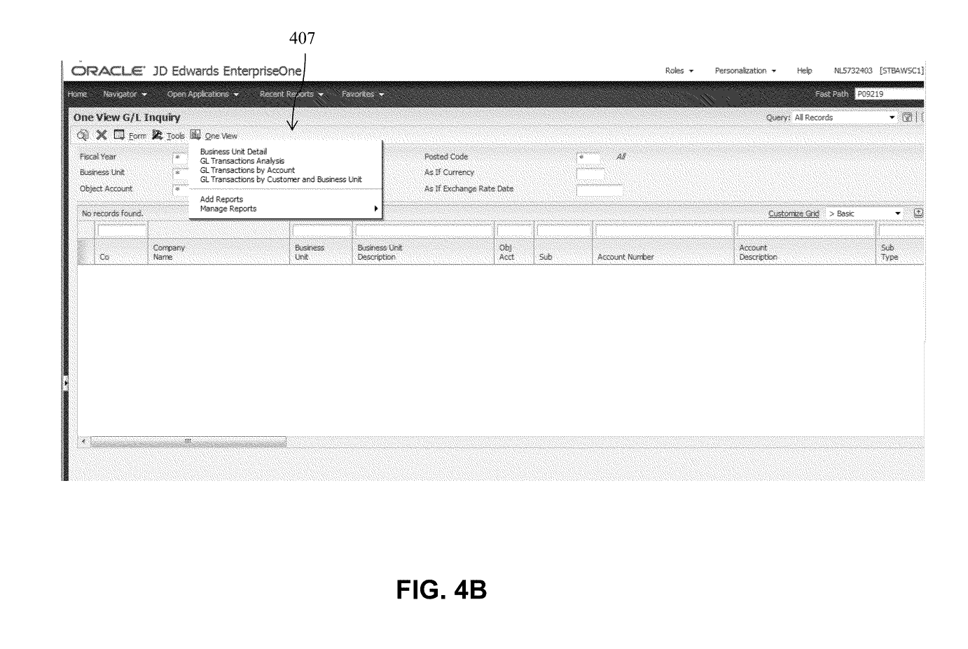

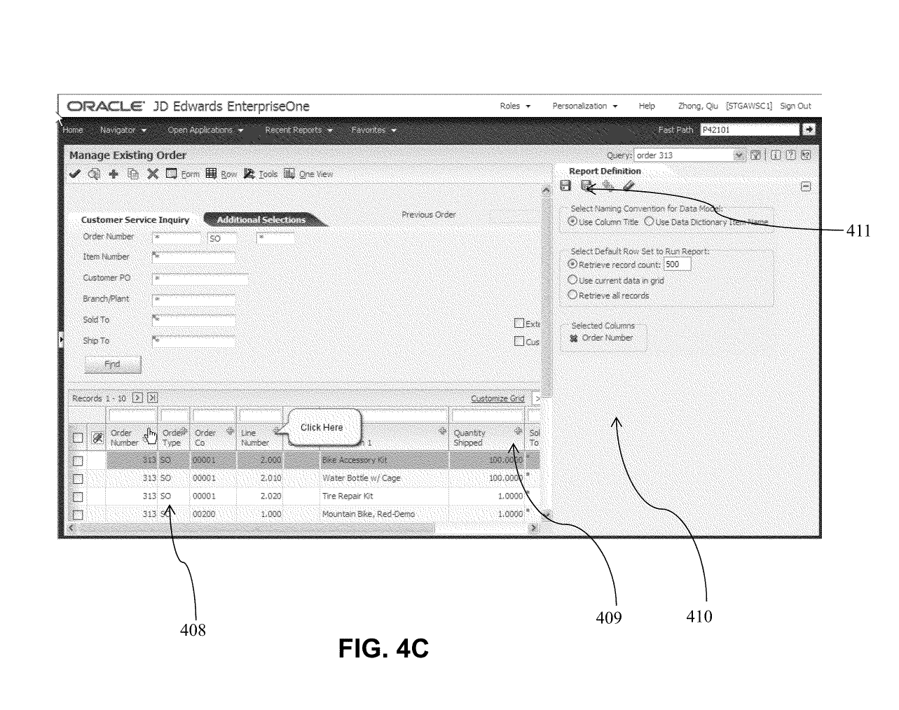

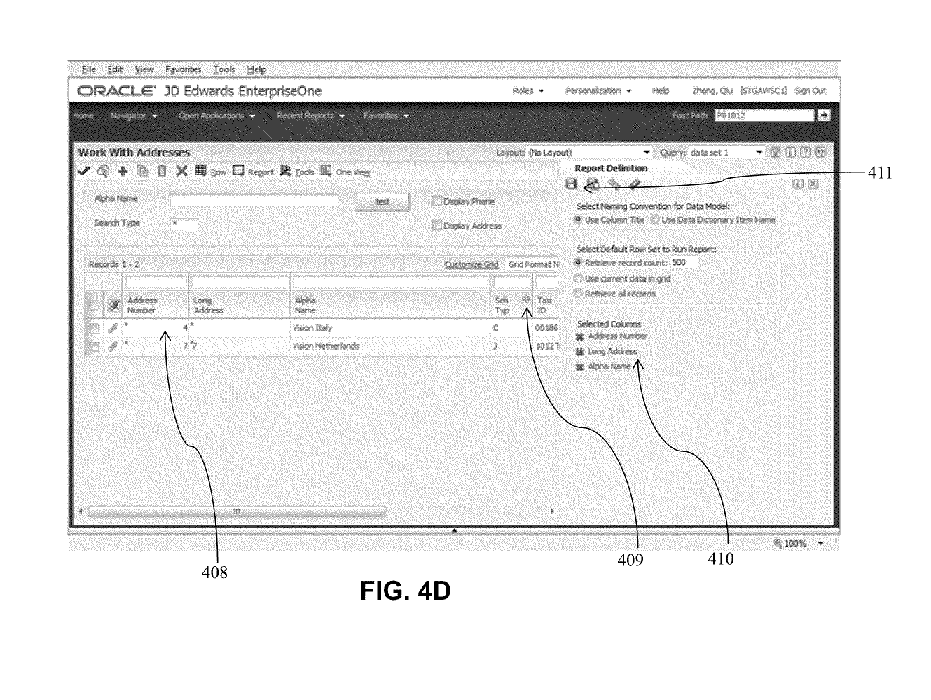

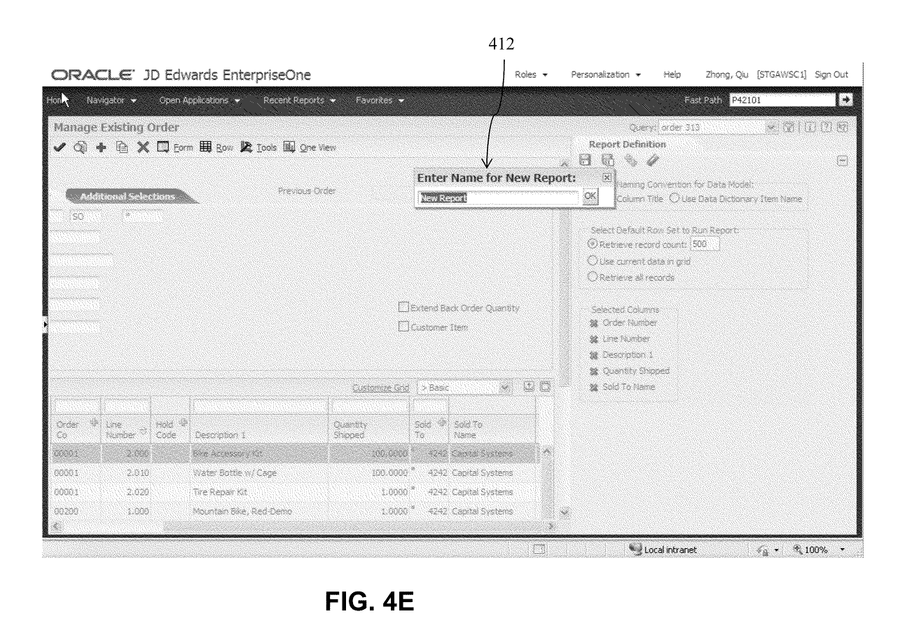

FIG. 3 illustrates a flowchart of an approach for designing a report definition, which shows the key components for allowing an end user to design a report from an interactive application. Initially, at 301, the user opens the ERP interactive application. In general, the user uses the interactive application to work with the data and transactions for which the report is desired. Next, at 302 and 303, the user will define and save a new report data model. These steps are described in more detail in FIG. 4.

In FIG. 4A, the creation of a new report data model is first initialized at 401. In some embodiments, an interface is provided in which an interface element (such as a button) is provided for the user to create the new report. For example, the interface may be configured to allow the user to click on an “Add New Report” button on a toolbar. An interface area (such as a Report Definition UI area) may then be displayed on the screen.

Next, data from the database is retrieved by the ERP application at and displayed to the user at 402. This may be data that the user was viewing when initializing the creation of a new report. In some embodiments, a user may request certain data to be displayed after initializing the creation of a new report. Data fields may be presented to the user to allow selection for the new report at 403. These data fields are extracted from the metadata established for the data/system. Interface elements are provided to display the data fields and for allowing selection of desired fields. For example, the system may display a “+” signs on data fields to allow them to be selected for a report, where the user clicks on a “+” sign to include the column in the report. The user can repeat this action until all desired data fields have been selected.

At 404, once the user has specified the data fields to be included in the report, the user may optionally specify additional configurations. Additional interface elements may be present allowing a user to specify these additional configurations, which may include the maximum number of rows in a data field that will be used to generate the report, or selecting the naming conventions for the data fields to be used in the report. For example, a user may wish to, due to performance issues, limit the number of rows that are used to generate the report, even though a data query may return a larger number of rows.

At 405, the user-selected data fields and configurations may then be saved (e.g., initiated by the User clicking on a “Save” button). The system saves the user selected data and data fields into a report data model which is stored in the database. In some embodiments, the report data model may be stored as an XML document.

FIGS. 4B-E illustrate screenshots of an ERP application in accordance with embodiments of the invention that allows for a user to specify data fields for a report data model and to save the report data model. FIG. 4B illustrates an ERP interactive application where a user may initialize the creation of a new report data model. The user may click the “One View” button on the toolbar to open a menu 407. The user then selects “Add Report” in menu 407.

FIG. 4C illustrates a screenshot of the application after a new report data model is initialized. The user is presented with data retrieved from the database at 408. Column headings of the displayed data for data fields that have not been selected may have a small button 409 shaped like a “+” sign, which the user may click on in order to add the particular data field to the report data model. A list of data fields that have already been selected may be displayed in a sidebar 410, with each selected data field having a button shaped like an “x” next to it, which the user may click on in order to remove the particular data field from the report data model.

Sidebar 410 also contains options for a user to specify additional configurations, including the number of rows the user wishes to be reported on, and the naming convention for data fields to be used in the report. Once the user has finalized the data fields to be included in the report data model, the user can then click the save button 411 to save the report data model to be stored in the database.

FIG. 4D illustrates another example screenshot of the application after a new report data model is initialized, where the user has already selected a plurality of data fields. In FIG. 4D, the data fields that have already been selected have no “+” sign button next to them.

FIG. 4E illustrates the ERP application once the user has finished selecting data fields for the report data model and clicked the save button. At 412, the user may be prompted to enter a name for the new report data model.

At 304, after the saving of the report data model, the system invokes a reporting tool to design the actual report definition. Any suitable reporting tool may be employed, such as the BI Publisher tool available from Oracle Corporation. In some embodiments, a reporting tool may be launched automatically by the ERP application when a user saves a report data model. In other embodiments, the user may choose to manually launch the reporting tool by clicking a button in the ERP application after saving a report data model, or launch the reporting tool independently.

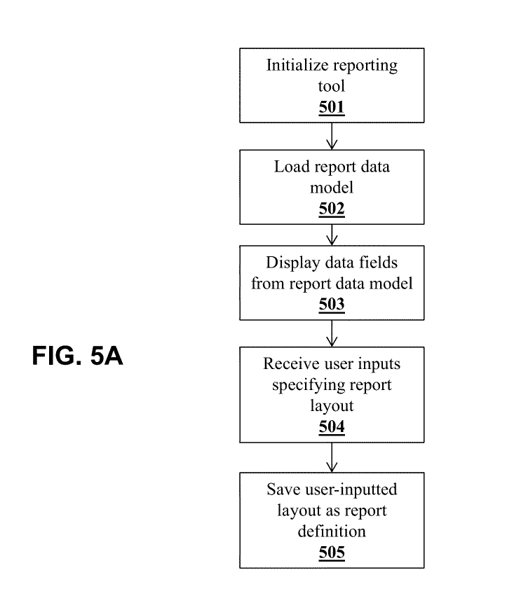

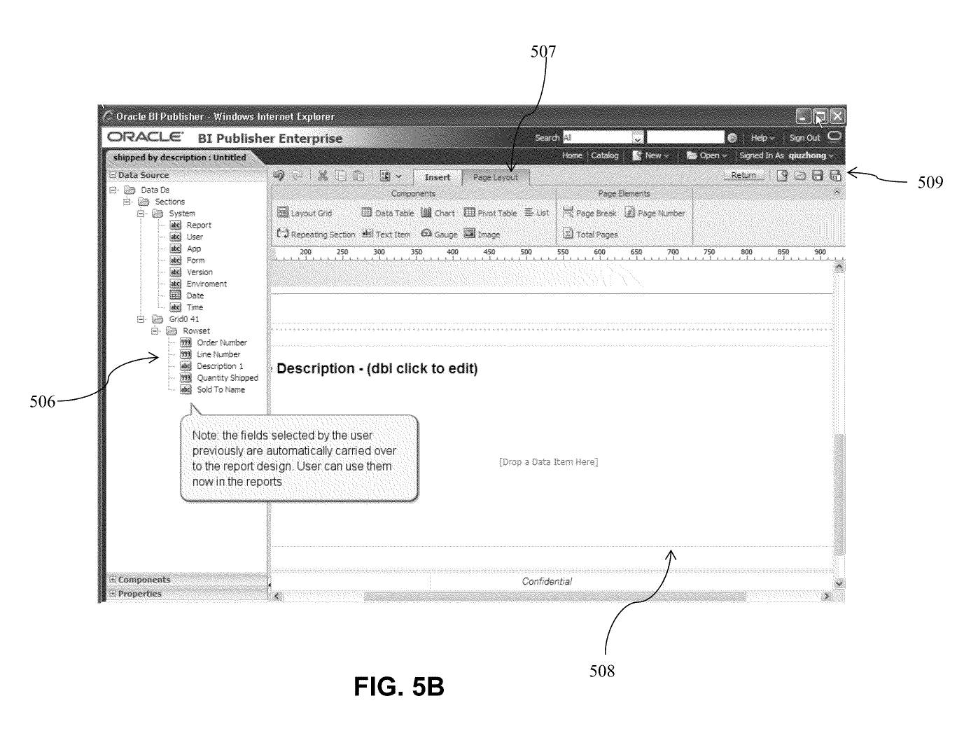

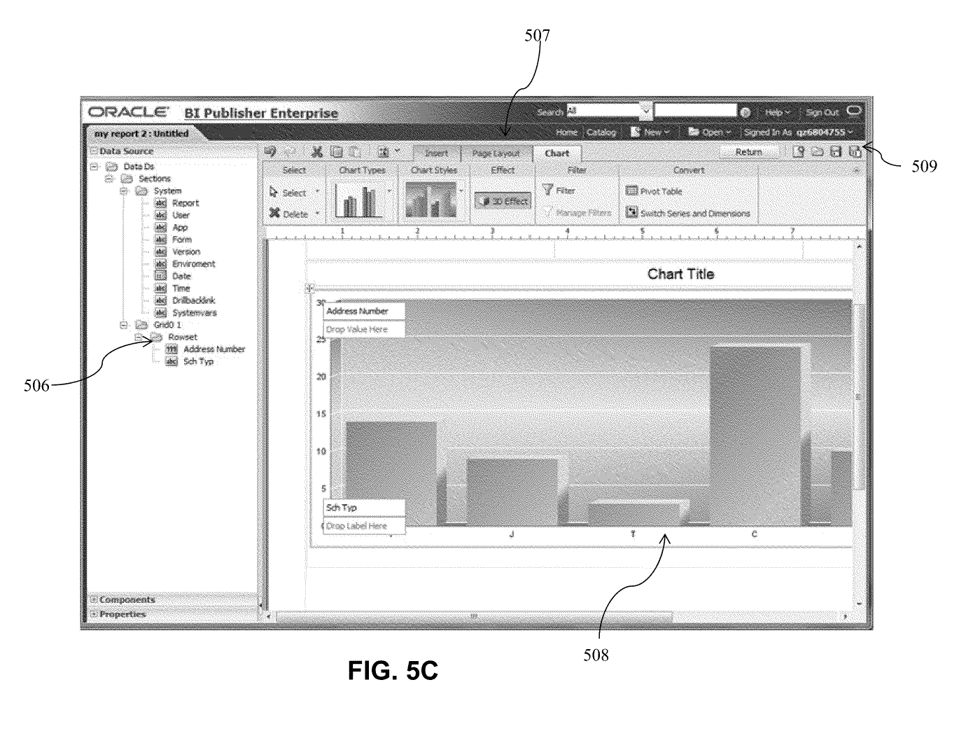

The saved report data model is then loaded into the reporting tool at 305. The user can then use the reporting tool to design the report at 306, using the data fields extracted from the report data model. Once the user has finished designing the report, the user then saves the design as a report definition data at 307. The steps taken by the reporting tool to generate the report definition are described in more detail in FIG. 5.

FIG. 5A illustrates a flowchart describing the actions taking by the reporting tool in accordance with certain embodiments of the invention. At 501, the reporting tool is initialized, either manually by the user or by being automatically invoked by the ERP application. Next, at 502, the report data model comprising the user-selected data fields is loaded. In embodiments where the reporting tool is invoked through the ERP application, the report data model may be loaded automatically through instructions passed to the reporting tool by the ERP application. For example, in embodiments where the ERP application automatically launches the reporting tool when the user saves a report data model, the ERP application may also pass information on the saved report data model to the reporting tool, so that the reporting tool can load the report data model automatically. In some embodiments, the user may manually select a saved report data model to be loaded into the reporting tool.

Once the report data model has been loaded, the data fields in the report data model may be displayed to the user at 503. Using the tools provided by the reporting tool, the user may then define a report layout based upon these data fields. The report layout specifies how the data is to be displayed in the end user report, and may comprise a plurality of data visualizations, such as tables, charts, and graphs. For example, in some embodiments, the user may click on a button to create a new graph, and specify that the data of a particular data field be associated with an axis of the graph by dragging and dropping a data field from where it is displayed to an axis of the graph. Once the user has finished defining the report layout, it is saved as a report definition at 505.

FIG. 5B illustrates a screenshot of a reporting tool in accordance with embodiments of the invention that allows for a user to generate a report layout. When the reporting tool is invoked and the report data model loaded, the reporting tool displays the data fields specified in the report data model to the user at 506. Here, the data fields are displayed as a list which the user can click, drag, and drop for use in the report. Using the displayed data fields, and the tools provided by the reporting tool at toolbar 507, the user is able to create a report layout in work area 508. The report layout may comprise instructions for creating different visual elements representing the data defined by the data fields. For example, there may be buttons for inserting a variety of visual elements into the report layout, including layout grids, data tables, charts, pivot tables, lists, and images. The user may also use the reporting tool to define additional format elements of the report, such as adding page breaks and inserting page numbers into the report.

FIG. 5C illustrates another screenshot of a reporting tool, wherein the user has already placed a visual element, a bar chart, into work area 508. In addition to tools for inserting visual elements and defining additional format elements of a report at toolbar 507, there may also be tools for the user to change the color, type, and style of a chart or other visual element that has been placed in work area 508.

The user may also modify various aspects of the chart in work area 508. For example, the user may change the title of the chart by clicking on the appropriate fields, and may specify which data fields the chart will represent by dragging the desired data fields at list 506 to the appropriate locations in the work area 508. When the user has finished defining the report layout, the resulting report definition may then be saved by clicking on the save button at 509. Once a report definition is saved, it is available to be executed by a user to create a new report.

The report definition created using the process described above and in FIGS. 3-5 comprises instructions on how that data for the report is to be formatted and displayed. However, in order to create an end user report, the user must also specify the actual data that is to be included in the report. To do this, the user uses the ERP query tool to define a set of queries that can be used to query the database for the necessary data.

FIG. 6 illustrates a flowchart of an approach for specifying a new set of queries. At 601, the user first initializes the creation of a new query set. In some embodiments, this can be done by the user simply clicking an “add new query” button in the user interface of the ERP application.

Next, data from the database is retrieved by the ERP application at and displayed to the user at 602. This may be data that the user was viewing when initializing the creation of a new query set. In some embodiments, a user may request certain data to be displayed after initializing the creation of a new query set. Data fields may be presented to the user to allow selection for the queries at 603. These data fields are extracted from the metadata established for the data/system. Interface elements are provided to display the data fields and for allowing selection of desired fields. For example, the system may display a “+” signs on data fields to allow them to be selected for the queries, where the user clicks on a “+” sign to include the data field as part of the queries. The user can repeat this action until all desired data fields have been selected. Once the desired data fields are selected, the user may then define the query criteria for the selected rows. For example, the user may define a query criteria specifying that the query return rows where the value in a selected data field contains a certain string, or falls within a user-defined numerical range. The user may define multiple criteria using the selected data fields. The user may configure whether a row is returned if it satisfies all of the query criteria, or just any of the criteria.

At 604, the ERP application extracts predicates based on the user inputs. The predicates may comprise logic based on the user selections specifying which rows in a data field are to be retrieved. For example, the predicates may comprise logic limiting the data to only include rows where the value in a certain column is within a user-specified range, or to only include rows where the value in a certain data field meets user-specified criteria.

At 605, once the ERP application has extracted the predicates based on the user's inputs and selections, the application automatically generates one or more queries based on the extracted predicates. The automatic generation of queries by the ERP application saves the user from having to understand how the data is structured in the underlying database, allowing for the user to make data selections using the more familiar and user-friendly ERP user interface. At 606, the user-defined set of queries may then be saved (e.g., initiated by the user clicking on a “Save” button) to the database.

FIG. 6B illustrates a screenshot of an ERP application in accordance with embodiments of the invention where the user may define a new set of queries. After initializing a new report data model, a user is presented with data retrieved from the database at 607. Column headings of the displayed data for data fields that have not been selected may have a small button 608 shaped like a “+” sign, which the user may click on in order to select the particular data field for the query. Data fields that have already been selected may have no “+” sign button next to them. A list of data fields that have already been selected may be displayed in a sidebar 609, with each selected data field having a button shaped like an “x” next to it, which the user may click on in order to remove the particular data field from being part of the query.

Sidebar 609 also contains menus, buttons, or other user interface features with which the user can specify query criteria for the selected data fields. For example, in FIG. 6B, the user has defined query criteria for the data fields “Sch Typ,” “Address Number,” and “Alpha Name.” For the “Sch Typ” data field, the user has defined the criteria that the value must in a list comprising the characters “E,” “C,” and “J.” For the “Address Number” data field, the user has defined the criteria that the value in the data field must be between 4 and 20. For the “Alpha Name” data field, the user has defined the criteria that the value in the data field must begin with the string “Vision.” The user has also selected that a row will only be returned by the query if all three criteria are satisfied. Once the user has finished defining query criteria, the user can then click the save button 610 to save the query to the database.

Once the user has both a report definition and a set of queries, a report can then be created. FIG. 7A illustrates a flowchart of an approach for allowing a user to execute the newly created report definition to create an end user report. At 701, the process begins by having the user select a pre-defined set of queries, e.g., as created using the process described above in FIG. 6, or by defining new query criteria corresponding to the data that the user wishes to view a report of, using the user interface of the ERP interactive application. At 702, the user then selects a report, e.g., as created using the process described above in FIGS. 3-5. In some embodiments, this may be done by selecting from a drop-down menu in the ERP application displaying available reports for the selected data. At 703, the data is then queried based on the queries defined in the report data model of the selected report. A query engine may be employed to perform this querying action. The data result of the queries is then processed and formatted in accordance with the report definition of the selected report to form an end user report than can be displayed to the user. Finally, then the report output is presented to the user at 704.

FIG. 7B illustrates a screenshot of an ERP application in accordance with embodiments of the invention where a user may execute a created report. As described above, the user first selects a query. The user may do this by selecting from a list of previously saved queries from a drop-down menu at 705. For example, the user here has selected a saved query named “data set 1.” The results of the query may be displayed by the application at 706. The user may then select in report to be displayed at 707. For example, in the illustrated embodiment, the user clicks the “One View” button to open a drop-down menu, which displays a list of available saved reports under “My Reports.” The user may then click on the desired report.

FIG. 7C illustrates a screenshot of a completed report that may be displayed after a user has selected a report, in accordance with embodiments of the invention. A completed end user report may contain a plurality of visual elements representing the data, depending on the report layout that was specified by the user. For example, the report illustrated in FIG. 7C contains a bar chart representing the data from the query, with the data field “Sch Type” on the horizontal axis, and the data field “Address Number” on the vertical axis.

FIG. 7D illustrates another example of an ERP application where the user may run a report. For example, in FIG. 7D, the user has selected a query name “order 313” at 705, and a report definition named “shipped by description” at 707.

FIG. 7E illustrates an additional example of an end user report. The report contains additional examples of visual elements that may be used in an end user report. The report illustrates a bar chart 708 on top, and a tabular set of data 709 below. In the illustrated example, the bar chart 708 plots the “Sold to Name” data fields, as shown in FIG. 7D, with the “Quantity” data field, separated with the “Description 1” data field.

As noted above, the creation of the ERP report depends upon the definition of the data fields that will be included in its output. It is important for the correct data tables and fields are chosen to meet the desired report requirements.

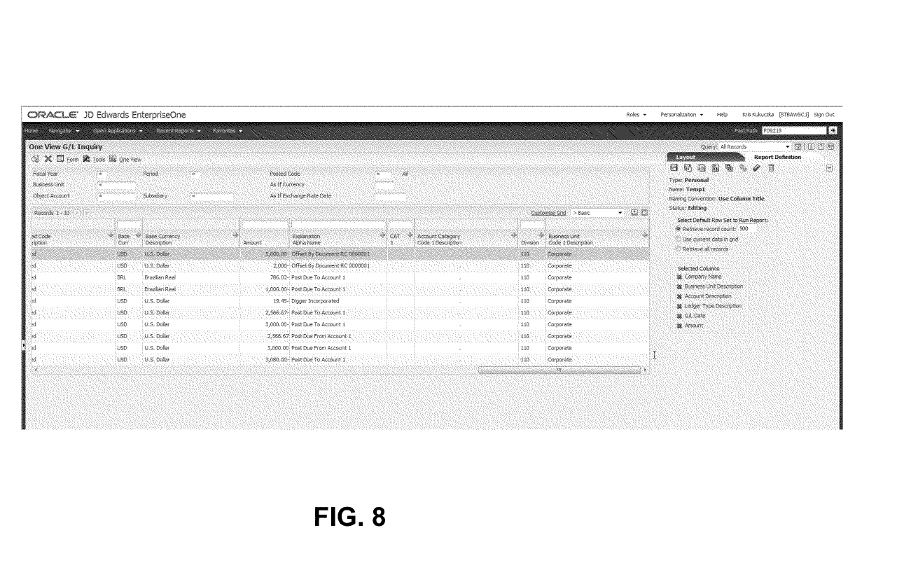

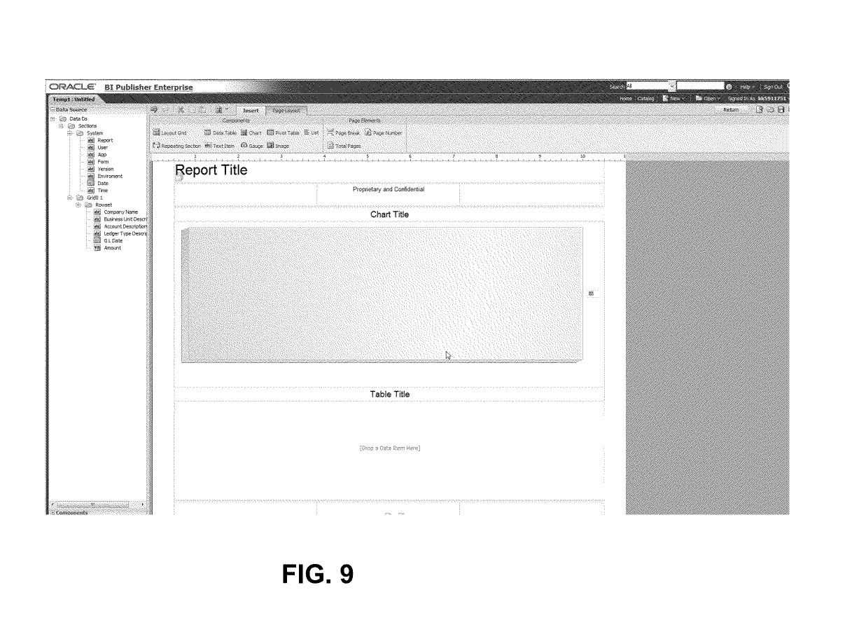

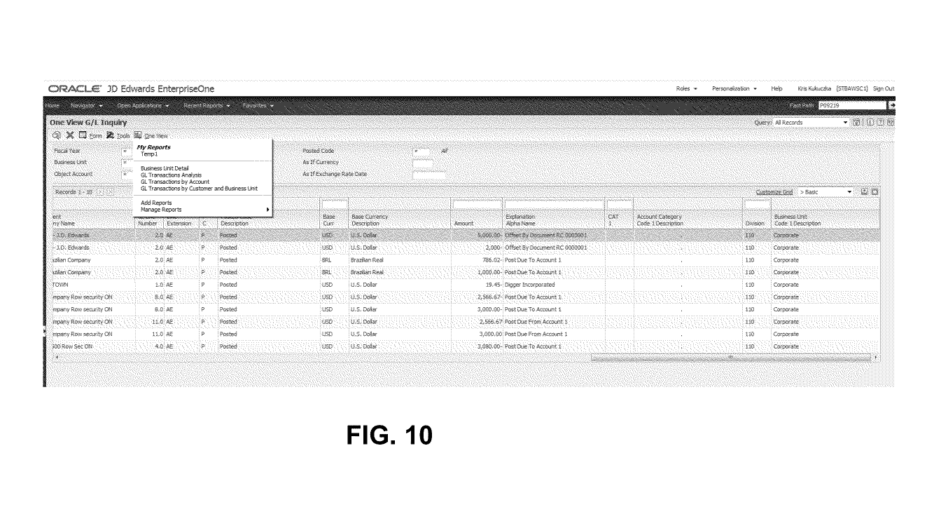

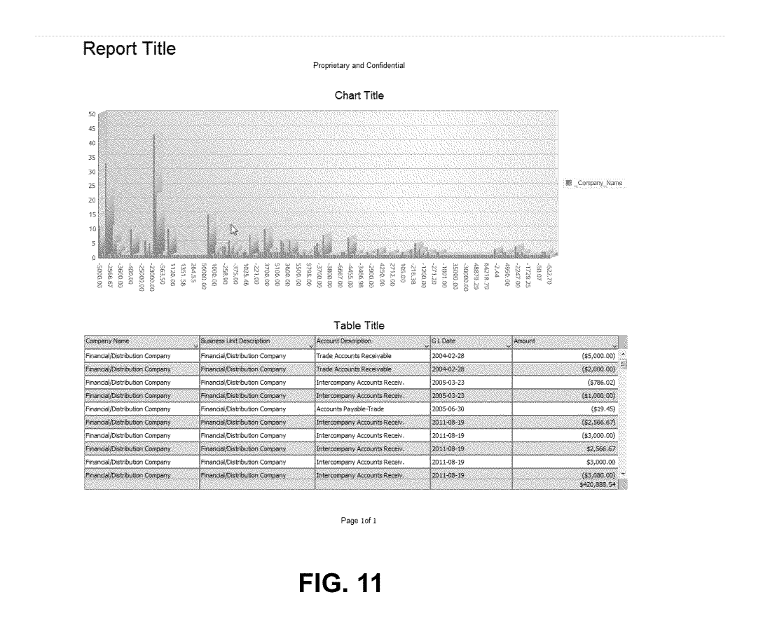

FIGS. 8-11 illustrate an example of implementing an end user report using the approach that has been described above. FIG. 8 illustrates a screenshot of an example interface for providing selection of data fields using this approach. FIG. 9 illustrates the data fields displayed for selection within a reporting tool. FIG. 10 illustrates that the report created in the reporting tool is made available within the ERP interactive application. FIG. 11 illustrates the final end user report created in the reporting tool that is displayed to the user, containing a chart and a table.

Traditional report creation tools require deep knowledge of the database schema and table relationships. While end users understand the data from the context of the applications they work in, they typically do not have the database schema and table relationship knowledge required to build reports using traditional reporting tools. This often leads to a reliance on IT to build these reports. End users define their report requirements and present them to IT to build. The need to involve IT makes the process costly and inefficient.

According to some embodiments of the invention, the invention provides an approach of using dynamic, intuitive, field selection to provide the ability to effectively choose the data fields necessary to meet the requirements for the specific report they wish to create without the involvement of IT staff.

It is understood that the users will understand the transactional data from the context of the ERP applications, while likely not really understanding the underlying table schema itself. The present solution leverages the interactive applications end users are familiar with by providing the ability to build a report data model by simply choosing data fields directly from within the interactive applications they work with on a daily basis. The system will pass these selected data fields to the reporting tool where they represent the report data model. Within the reporting tool, the report data model with its data fields are available for the user to apply to their own custom report.

When the user executes their report, the system retrieves the data from the database and filters the data with the Report Data Model. The system packages the filtered data and generates a report using the layout the user has designed for the report.

Therefore, what has been described is a new approach that efficiently provides for end user reporting from interactive applications. One embodiment provides an approach for implementing dynamic field selection in the end user reports. The present embodiment provides for an interactive application that allows users to query data with query capabilities. The user is able to select data fields to be included in the reports intuitively, and directly from the interactive application screen. A metadata mechanism is employed to store the data fields (data model) of the reports. An interactive report design tool that allows user to design the report with a variety of charts, graphics and tables. An engine that queries the data based on the user defined query criteria, packages the user selected fields within the data and generate the report output on the fly.

Conventional ERP system fail to provide for such an effective, efficient, dynamic, intuitive method for end users to effectively choose the data fields for report creation. In the present embodiment, data field selection is an important feature that facilitates end user reporting solution which provides business insight to organizations without incurring IT development costs. Selecting data fields by simply pointing and clicking from within familiar applications makes the solution very easy to use, even for novice users. Users do not require knowledge of the data schema including tables, joins and data fields to retrieve the proper data. This is all handled by the interactive application which makes this solution a truly end user solution.

### System Architecture Overview

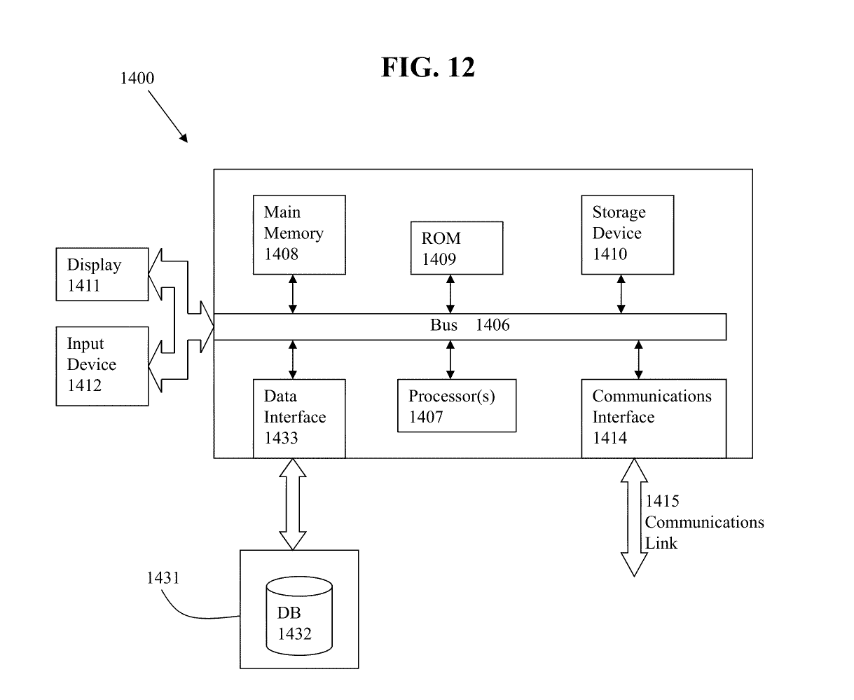

FIG. 12 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method for generating a report definition for an resource management system, comprising the steps of:
receiving a plurality of user inputs at an resource management application, comprising selections for a plurality of report parameters;
creating a report data model based at least in part on the user inputs;
loading the report data model into a reporting tool; and
designing a report definition using the reporting tool, wherein the report definition is based at least in part upon the report parameters from the report data model.

2. The method of claim 1, wherein the resource management system is an ERP system.

3. The method of claim 1, wherein the report definition defines visualization aspects of the report.

4. The method of claim 1, wherein the report parameters comprise data fields to be included in the report.

5. The method of claim 4, wherein the report parameters further comprise which rows in a data field are to be included in the report.

6. The method of claim 1, wherein the reporting tool is invoked through the resource management application.

7. The method of claim 1, wherein the report data model and the report definition are saved to a computer storage device.

8. The method of claim 1, further comprising the steps of:
receiving a user input at the resource management application selecting one or more queries;
receiving a user input selecting a report definition;
querying the database using the selected queries; and
generating report based at least in part on the data returned by the database in response to the queries, and on the report definition of the selected report.

9. The method of claim 8, wherein the one or more queries are generated automatically by the resource management application based at least in part on a plurality of user inputs at the resource management application.

10. A system for generating a report for an resource management system, comprising:
a database containing data for which a report is to be generated;
a resource management application, wherein the resource management application is configured to receive inputs from a user selecting a plurality of report parameters and to create a report data model based at least in part upon the selected report parameters; and
a reporting tool, wherein the reporting tool is configured to load a report data model and to receive inputs from a user to create a report definition.

11. The system of claim 10, wherein the resource management system is an ERP system.

12. The system of claim 10, wherein the report definition defines visualization aspects of the report.

13. The system of claim 10, wherein the report parameters comprise data fields to be included in the report.

14. The system of claim 13, wherein the report parameters further comprise which rows in a data field are to be included in the report.

15. The system of claim 10, wherein the reporting tool is invoked through the resource management application.

16. The system of claim 10, wherein the report data model and the report definition are saved to a computer storage device.

17. The system of claim 10, wherein the resource management application is further configured to allow a user to execute a report definition, comprising the steps of:
receiving a user input at the resource management application selecting one or more queries;
receiving a user input selecting a report definition;
querying the database using the selected queries; and
generating report based at least in part on the data returned by the database in response to the queries, and on the report definition of the selected report.

18. The system of claim 17, wherein the one or more queries are generated automatically by the resource management application based at least in part on a plurality of user inputs at the resource management application

19. A computer program product including a non-transitory computer readable medium having instructions which, when executed by a processor, causes the processor to perform a process for generating a report definition for an resource management system, the process comprising:
receiving a plurality of user inputs at an resource management application, comprising selections for a plurality of report parameters;
creating a report data model based at least in part on the user inputs;
loading the report data model into a reporting tool; and
designing a report definition using the reporting tool, wherein the report definition is based at least in part upon the report parameters from the report data model.

20. The computer program product of claim 19, wherein the resource management system is an ERP system.

21. The computer program product of claim 19, wherein the report definition defines visualization aspects of the report.

22. The computer program product of claim 19, wherein the report parameters comprise data fields to be included in the report.

23. The computer program product of claim 22, wherein the report parameters further comprise which rows in a data field are to be included in the report.

24. The computer program product of claim 19, wherein the reporting tool is invoked through the resource management application.

25. The computer program product of claim 19, wherein the report data model and the report definition are saved to a computer storage device.

26. The computer program product of claim 19, further comprising the steps of:
receiving a user input at the resource management application selecting one or more queries;
receiving a user input selecting a report definition;
querying the database using the selected queries; and
generating report based at least in part on the data returned by the database in response to the queries, and on the report definition of the selected report.

27. The computer program product of claim 26, wherein the one or more queries are generated automatically by the resource management application based at least in part on a plurality of user inputs at the resource management application.
